(19) United States
(12) Patent Application Publication
(10) Pub. No.: US 2008/0313365 A1
(43) Pub. Date: Dec. 18, 2008

(54) Controlling write transactions between initiators and recipients via interconnect logic

(75) Inventor: Alastair Crone Bruce, Stockport (GB)

Correspondence Address: NIXON & VANDERHYE P.C., 901 N. Glebe Road, 11th Floor, Arlington, VA, 22203-1808, US

(73) Assignee: ARM Limited, Cambridge (GB)

(21) Appl. No.: 12/153,534

(22) Filed: May 20, 2008

(30) Foreign Application Priority Data
Jun. 14, 2007 (GB) 0711563.7

(51) Int. Cl. G06F 3/00

(52) U.S. Cl. 710/38

(57) ABSTRACT

There is disclosed a method of writing data from an initiator to a recipient via an interconnect block, comprising the steps of:
(i) transmitting a write transaction request comprising an address indicating a destination for said write data from said initiator to said interconnect block;
(ii) said interconnect block routing said write transaction request to said recipient in dependence upon said address;
(iii) in response to receipt of said write transaction request at said recipient, said recipient determining said recipient's availability for receiving write data relating to said write transaction request; and
(iv) in response to determining it is available transmitting an available request specific to said write transaction request to said interconnect block;
(v) said interconnect block routing said available request to said initiator;
(vi) said initiator transmitting at least some of said write data relating to said write transaction request to said interconnect block in response to receipt of said available request; and
(vii) said interconnect block routing said at least some of said write data to said recipient.

### BACKGROUND OF THE INVENTION

1. Field of the Invention

The present invention relates to interconnecting masters and slaves within a data processing apparatus, and in particular to techniques for controlling write transactions between master devices and slave devices coupled to interconnect logic.

2. Description of the Prior Art

Within a data processing apparatus having a plurality of master units and slave units, it is known to provide interconnect logic for coupling the master units and the slave units to enable transactions to be performed. Each transaction consists of an address transfer from a master unit to a slave unit, and one or more data transfers between that master unit and that slave unit. For a write transaction these data transfers will pass from the master unit to the slave unit (in some implementations there will additionally be a write response transfer from the slave unit to the master unit indicating when the data transfer has successfully completed), whilst for a read transaction these data transfers will pass from the slave unit to the master unit. Any transfers from a slave unit to a master unit are referred to herein as response transfers.

FIG. 1 schematically shows write data routing according to the prior art. Address transfers are routed to the desired slave by decoding the address in the payload (address decode 2). The transaction ID and the slave number are stored in a content addressable buffer within routing logic 5 so that write data transfers can be routed to the correct slave by looking up the slave number from the ID. This requires significant data storage. A typical interconnect implementation appends the master number to the transaction ID 6. When a slave generates a response it will use this composite ID. The interconnect 8 then splits off the master number and routes the response to the correct master.

The interconnect logic will provide a plurality of connection paths for coupling the various master units and slave units. The way in which the various transfers are routed via those connection paths will be dependent on the bus protocol employed within the interconnect logic. One known type of bus protocol is the non-split transaction protocol, such as is employed within a data processing apparatus having an AHB bus designed in accordance with the AHB bus protocol developed by ARM® Limited, Cambridge, United Kingdom. In accordance with such a non-split transaction protocol, there is a fixed timing relationship between the address transfer of a transaction and the subsequent one or more data transfers of that transaction. In particular, the data transfer starts in the cycle following that in which the address is transferred. Due to the fixed timing relationship between the address transfers and data transfers, then it will be appreciated that the data transfers of multiple transactions occur in the same order as the address transfers.

As interconnect logic increases in complexity, due to the need to support the interconnection of a larger number of master and slave units, then another type of bus protocol has been developed known as a split transaction protocol. In accordance with such a split transaction protocol, the plurality of connection paths within the interconnect logic provide at least one address channel for carrying address transfers and at least one data channel for carrying data transfers. An example of such a split transaction protocol is the AXI (Advanced eXtensible Interface) protocol developed by ARM® Limited, Cambridge, United Kingdom. The AXI protocol provides a number of channels over which information and data can be transferred, these channels comprising a read address channel for carrying address transfers of read transactions, a write address channel for carrying address transfers of write transactions, a write data channel for carrying data transfers of write transactions, a read data channel for carrying data transfers of read transactions, and a write response channel for returning transaction status information to the master unit at the end of a write transaction, such transaction status information indicating for example whether the transaction completed successfully, or whether an error occurred, etc. Use of such a split transaction protocol can increase the performance of a system compared with a similar system using a non-split transaction protocol.

Conventionally, read transactions using such a split transaction protocol are better behaved than write transactions. With write transactions a slave has no way of controlling the write transaction's data flow other than by blocking its address or write data channels. In a system where many masters are in communication with the same slave this can lead to poor performance or even deadlock.

In particular, when adopting a split transaction protocol, data transfers over a data channel are prioritised according to the temporal ordering of the corresponding address transfers over the relevant address channel, such that data pertaining to earlier addresses (i.e. addresses transferred earlier over the address channel) are given priority over data pertaining to later addresses.

An enhancement that may be used to allow some local re-ordering of transactions at a particular slave unit when using interconnect logic conforming to such a split transaction protocol is described in U.S. patent application Ser. No. 10/743,537 filed on Dec. 23, 2003, for which ARM® Limited is the assignee.

Write data interleaving is possible in split transaction protocols, however, there is the potential for deadlock if the slave's interleave capability is exceeded.

Consider the case where a slave has an interleave capability of one but the system tries to interleave two transactions. The interconnect has posted two write addresses with IDs A and B. The first address (ID A) has been accepted by the slave, which is now ready for the data for that transaction. The other address (ID B) has been stored in an address buffer and so has not yet reached the slave. Because the slave only has the address information for ID A it will only accept data with ID A. If the interconnect now tries to send data for transaction ID B the slave will not be able to accept the data and so the write channel will block. The slave cannot accept any more addresses and cannot process any more data for the address it already has. It is now deadlocked.

This deadlock condition can be guarded against by statically configuring an interconnect with the write interleave depth of every attached slave.

Furthermore, in conventional systems having cascaded interconnect blocks the write interleave depth for the slave ports of these blocks is set to one, to avoid the possibility that the write interleave depth of a connected slave is exceeded. This avoids the above described interlock condition occurring but produces a fairly inefficient system.

It would be desirable to be able to control write transactions to behave well and avoid interlock situations without unduly restricting the functionality of the master and slaves.

### SUMMARY OF THE INVENTION

A first aspect of the present invention provides a method of writing data from an initiator to a recipient via an interconnect block, comprising the steps of: (i) transmitting a write transaction request comprising an address indicating a destination for said write data from said initiator to said interconnect block; (ii) said interconnect block routing said write transaction request to said recipient in dependence upon said address; (iii) in response to receipt of said write transaction request at said recipient, said recipient determining said recipient's availability for receiving write data relating to said write transaction request; and (iv) in response to determining it is available transmitting an available request specific to said write transaction request to said interconnect block; (v) said interconnect block routing said available request to said initiator; (vi) said initiator transmitting at least some of said write data relating to said write transaction request to said interconnect block in response to receipt of said available request; and (vii) said interconnect block routing said at least some of said write data to said recipient.

By providing control of the write data within the recipient itself the properties of the recipient and its ability to receive data or not are known and thus, rather than a write channel being blocked while a write transaction waits to complete to a recipient that is not ready, the write data part of the transaction can not be initiated until it is known that the recipient is indeed ready to receive the data and thus, no blockage of write channels need occur. In effect the write transaction occurs much like a read transaction would and these are generally well behaved as they involve some “handshaking” between master and recipient prior to data transfer. Thus, in a relatively simple manner and at the cost of one extra signal the blocking of write channels due to recipients having been allocated the channel but not being ready is avoided and potential deadlock conditions that arises when the write interleave depth of a recipient is exceeded are avoided. Conventionally this was addressed by setting the interleave depth of a slave interface port on an interconnect to one. This was a limitation on the utilisation of the available bandwidth.

In some embodiments, said write transaction request received at said recipient comprises a transaction identifier.

Although the write transaction request may not comprise an identifier, in preferred embodiments it does do so as this enables the interconnect logic to receive more than one write transaction from the same initiator at any one time and still be able to distinguish between them. If there is no transaction identifier then the system is limited to processing write transactions or at least unidentified write transactions in order.

In some embodiments, said write transaction request transmitted by said initiator comprises at least a portion of said transaction identifier.

It may be that the write transaction request comprises at least a portion of a transaction identifier when it is transmitted by the initiator. In some embodiments it may be completely identified whereas in others it may just have a portion of an identifier, the transaction being fully identified later by the interconnect logic.

In some embodiments, said step (ii) of routing said write transaction request to said recipient by said interconnect block comprises appending at least a part of said transaction identifier to said transaction request received from said initiator prior to transmitting said transaction request to said recipient.

In some embodiments, said step (ii) further comprises appending an initiator identification to said write transaction request prior to transmitting it to said recipient, said available request transmitted by said recipient comprising said transaction identifier and said initiator identification.

In embodiments where the interconnect block connects to more than one initiator it must append an initiator identifier to the transaction identifier given by the initiator thereby distinguishing between transactions with the same identifier but from different initiators. If the initiator is a very simple device then it may not have provided a transaction identifier and the identifier supplied by the interconnect block will be the complete transaction identifier.

In embodiments where the interconnect block only connects to a single initiator then there may be no transaction identifier. In such embodiments all transactions will be performed in the order they are initiated.

The interconnect logic is able to append an initiator identifier because it is the interconnect logic that received the request from the initiator and it therefore knows where it has come from and thus, it is a simple matter to append this information. Furthermore, as there are not a huge number of initiators communicating with the interconnect block then this identification can take a relatively small number of bits and be simple and quick to use for routing. Conventionally the logic used for routing needed to store the coded address information and to look it up and decode it prior to routing, thereby entailing a time penalty.

In some embodiments, said step (ii) further comprises said interconnect block deriving a composite identifier from said transaction identifier within said write transaction request and said initiator identification and appending said composite identifier to said write transaction request.

Although, the initiator identification and the transaction identifier can be separate identifiers, in some embodiments they are a composite identifier. This has the advantage that it generally takes fewer bits, however, it has the disadvantage that it requires more logic and as such is generally only used where the number of ID bits is constrained in some way.

In some embodiments, said step (v) of said interconnect block routing said available request to said initiator comprises said interconnect block determining which initiator to route it to from said initiator identification and comprises said interconnect block removing said initiator identification from said available request and appending a recipient identification to said signal prior to transmitting it to said initiator.

Appending an initiator identification to a write transaction request enables the recipient to take this identification and attach it to its available request that is its response. Thus, the interconnect logic can determine which initiator to route the available request to very simply from this initiator identification attached to the available request. This clearly simplifies the interconnect logic required and enables the communicating devices to be identified in a simple and low bandwidth manner. Furthermore, the interconnect block can determine a recipient identification from where the available request is received from and it can append a recipient identification to that signal, which can be used later when routing the write data itself.

In some embodiments, said step (vi) of said initiator transmitting at least some of said write data comprises an initial step of said initiator appending said recipient identification and said transaction identification to said at least some of said write data prior to transmitting it.

The recipient information appended to the available request can be used by the initiator to append to the write data such that the interconnect logic can once again route the write data in a very simple manner.

In some embodiments said step (iii) of said recipient determining its availability comprises determining a number of data items it is available to receive, said available request transmitted comprising an indication of a number of data items said recipient is available to receive, and said step (vi) of said initiator transmitting at least some of said write data comprises said initiator transmitting said number of data items from said write data indicated in said recipient available request.

Although in some embodiments a whole data transfer request may be transmitted at one time, it may be advantageous to split it into smaller portions and thus if there is a large data transfer to be performed it does not block the interconnect logic for a long length of time. Embodiments of the invention allow this by the recipient determining the number of data items it is able to receive at a particular moment and sending this information back with its available request. Thus, only the number of data items that can be processed by the recipient are sent at any one time and the interconnect logic is therefore not blocked.

Although in some embodiments a whole data transfer request may be transmitted at one time, it may be advantageous to split it into smaller portions when the recipient is unable to receive all the data in one portion. In these embodiments, said step (iii) of said recipient determining its availability comprises continually determining said number of data items said recipient is available to receive and transmitting further available requests when it is determined that a further number of data items can be received said further available requests comprising said further number of data items, until said recipient has received all of said data items.

This gives the recipient greater flexibility to interleave the write data from several initiators. A receiver would otherwise have to wait until it could accept all the data for a transaction before sending the data request for it. The receiver must always ensure that no other transactions consume the resources needed by the write data that has already been requested. The recipient knows from the control information how large the complete data transfer is and thus, it can continue to send available requests until it determines that it has sent available requests for the sufficient number of data items and therefore the data transfer request is complete.

In some embodiments, the method comprises a further step (viii) of in response to said recipient determining said write transaction has completed, said recipient transmitting a write response.

When the write transaction has completed then a write response is sent back to enable the interconnect logic to know that this transaction has now finished and another transfer can be started.

In some embodiments, said step (i) of transmitting a write transaction request is performed a plurality of times before steps (ii) to (vii) have completed, wherein step (iii) further comprises determining said recipient's availability for a particular write transaction from said plurality of write transaction requests received in dependence upon said transaction identifiers and at least one predetermined condition and step (iv) comprises transmitting said available request specific to a selected next write transaction request to be processed.

It may be advantageous to be able to select between the write transfer request that are processed at the recipient and thereby offer improved quality of service by being able to process high priority data transfers before other data transfers. Predetermined conditions could be set such that the desired priorities are acted upon.

In some embodiments said predetermined condition comprises a priority rating of an initiator said write transaction request is received from.

Clearly a number of different predetermined conditions could be used but in some embodiments initiators are given high priority and therefore they receive a better quality of service.

A second aspect of the present invention provides interconnect logic for coupling initiators and recipients within a data processing apparatus to enable transactions to be performed, each transaction comprising an address transfer from an initiator to a recipient and one or more data transfers between said initiator and said recipient, at least one of said transactions being a write transaction from said initiator to said recipient, said interconnect logic comprising: a plurality of connection paths operable to provide at least one address channel for carrying address transfers, at least one data channel for carrying data transfers, and at least one response channel for carrying a response from said recipient; wherein said interconnect logic is responsive to receipt of a write transaction request comprising a write address from said initiator, to identify said recipient from said write address and to transmit said write transaction request via said address channel to said identified recipient; and said interconnect logic is responsive to receipt of an available request corresponding to said write transaction from said recipient, to transmit said available request to said initiator; and said interconnect logic is responsive to receipt of signals comprising at least some of said write data of said write transaction to transmit said at least some of said write data to said recipient.

In some embodiments said available request is transmitted on said response channel.

Although the available request could be transmitted on the data channel between the recipient interconnect logic and initiator, in some embodiments it is transmitted on the response channel and it is distinguished from the data transfer finished response by having a different signal. Thus, one extra bit on this channel enables an available request to be sent.

A third aspect of the present invention provides an initiator for performing transactions with recipients via interconnect logic, said initiator comprising input and output logic for performing a write transaction, said output logic being adapted to output a write transaction request comprising a write address to a recipient via interconnect logic, and to not output write data associated with said write transaction until said input logic has received an available request relating to said transaction from said recipient, said output logic being adapted to output at least some of said write data to said recipient in response to receipt of said available request at said input logic.

In some embodiments said available request is output to a response channel and comprises an identification bit for identifying said request as said available request rather than a write finish indication.

In order to distinguish the available request on the write finish indication there is an additional identification bit on the response channel. In this way a single additional bit can be used to provide an available response.

A fourth aspect of the present invention provides a data processing apparatus comprising at least one initiator according to a second aspect of the present invention, at least one recipient according to a third aspect of the present invention said at least one initiator and said at least one recipient being interconnected via interconnect logic according to a second aspect of the present invention.

Although the initiator and the recipient can be a number of different things, in some embodiments the initiator is a master device whereas the recipient is a slave device.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates in a functional manner interconnect logic according to the prior art;

FIG. 2 schematically illustrates a data processing apparatus comprising masters, slaves and interconnect logic according to an embodiment of the present invention;

FIG. 3 schematically illustrates in a functional manner interconnect logic according to an embodiment of the present invention;

FIG. 4 schematically shows signals received and sent from masters to slave via interconnect logic;

FIG. 5 shows the waveforms for a typical transfer on a generic AXI channel; and

FIG. 6 illustrates the steps in a method according to an embodiment of the present invention.

### DESCRIPTION OF THE PREFERRED EMBODIMENTS

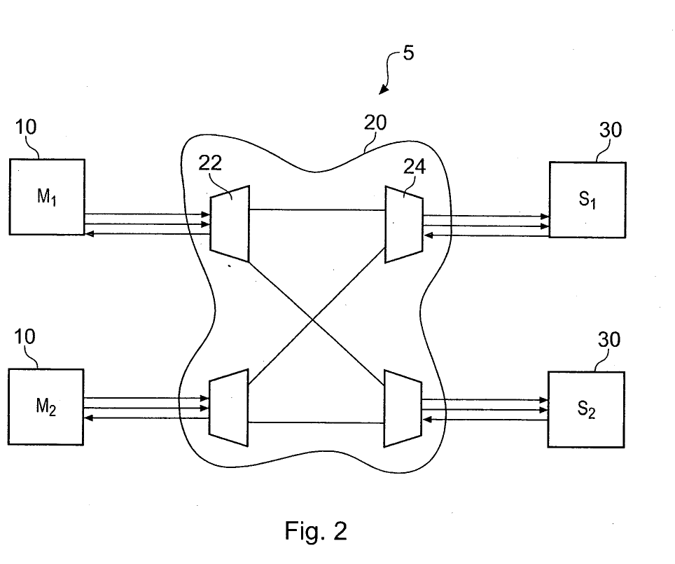

FIG. 2 shows a data processing apparatus 5 according to an embodiment of the present invention. Data processing apparatus 5 comprises a plurality of masters 10, interconnect logic 20 and a plurality of slaves 30. In this diagram, there are only two masters and two slaves shown for clarity. It will be appreciated that in reality there can be many more masters and slaves and in fact there can be cascaded interconnect logic as well.

A master 10 sends a write data transaction request via interconnect logic 20 to one of the slaves 30. Interconnect logic 20 comprises decoders 22 and arbiters 24. Decoder 22 looks at the address information within the write data request and identifies the slave 30 that it is to send a data request to from this address information and it then sends the data request to the appropriate slave via the appropriate arbiter 24.

Slave 30 receives the data transaction request and when it is available to process it, it sends back a response on a response channel, indicating that it is ready to process the write data transaction. Interconnect logic receives this response and routes it to the master 10 that the write data transaction request was received from. In response of this the write data is sent by the master to the slave.

In addition to routing the signals the interconnect logic 20 also acts to append master and slave identifiers to the signals thereby facilitating their routing. In particular, a write data transaction request that is received at interconnect logic 20 from master 10, comprises an address which indicates where it is to be sent and a transaction identifier. The decoder 22 within interconnect logic 20 identifies the slave that is to receive this request from the address and as it knows which master it was received from it appends a master identifier to the request that it then sends to the slave. The slave then appends this master identifier to its available response and the interconnect logic which receives the available response therefore knows which master to route it to. The identification of the master from the identifier can be simply done using comparison logic within the interconnect logic. Once it has determined which master is to receive the response, it removes the master identifier from the available response and attaches the slave identifier as at this point it knows which slave it received the response from. This slave identifier is then appended by the master that receives the response to the write data that it sends in reply to it and thus the write data can be very simply routed by interconnect logic 20 to the correct master. Once again, the use of comparison logic with known slave identifiers within the interconnect logic 20 is used for this routing.

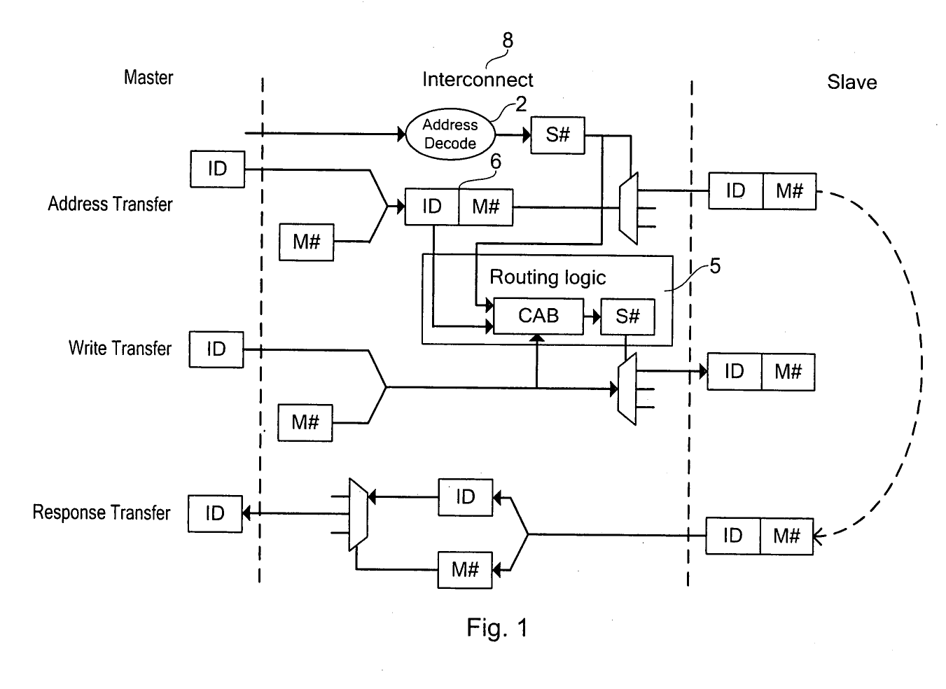

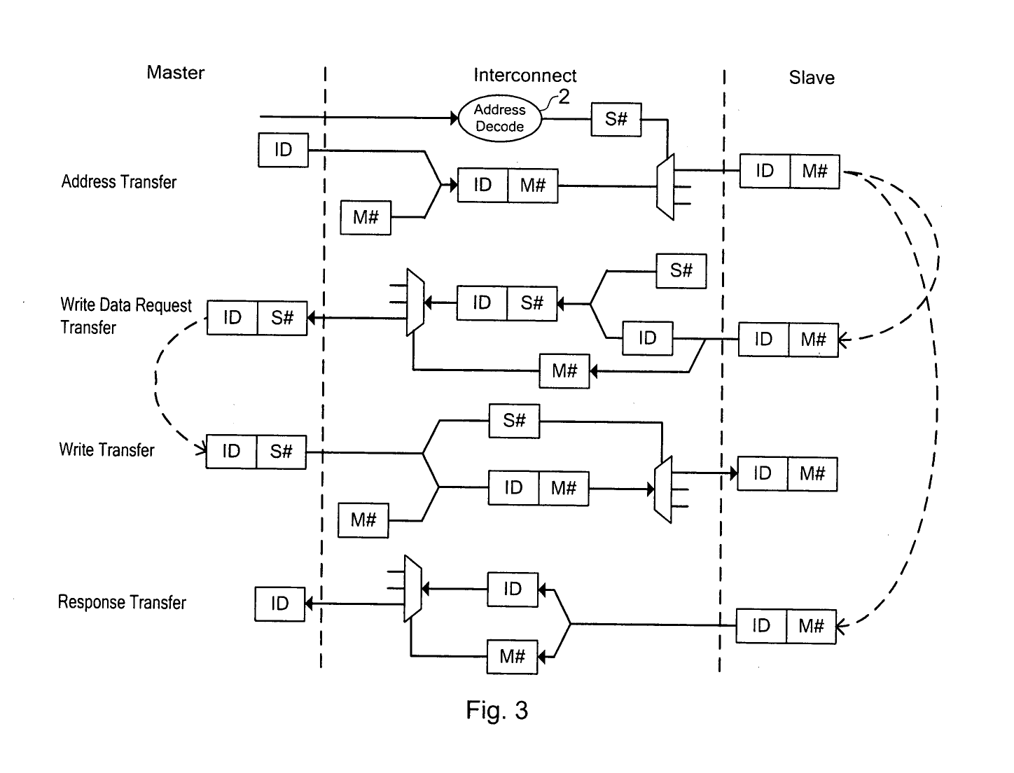

FIG. 3 functionally shows interconnect logic connecting a master and slave according to an embodiment of the present invention. This figure illustrates these devices in a similar way to that used in the illustration of the prior art given in FIG. 1. In this embodiment the slave ID S# generated from the address decode 2 is used to direct the initial address transfer to the appropriate salve as it is in the prior art. However, at this point the embodiment differs from the prior art in that a write data request signal is generated in the slave to indicate that it can receive data and this is sent to the interconnect logic. This signal comprises the transaction ID and the master identifier M#. It may also contain an indication of a number of data items it can receive although this is not shown in this embodiment. The interconnect logic appends the slave identifier S# to this signal as it knows which slave it has received the signal from and the master identifier M# is used to route the write data request transfer to the appropriate master. In response to this signal the master sends the data in a write transfer signal and the slave identifier S# that was appended to the write data request signal is used to route the write transfer signal to the appropriate slave. Interconnect logic identifies the master the signal is received from and appends a master identifier M# to the data transfer with the transaction ID, and thus, when the data has been transferred a response transfer signal indicating that the transfer is complete can be routed to the correct master using this identifier.

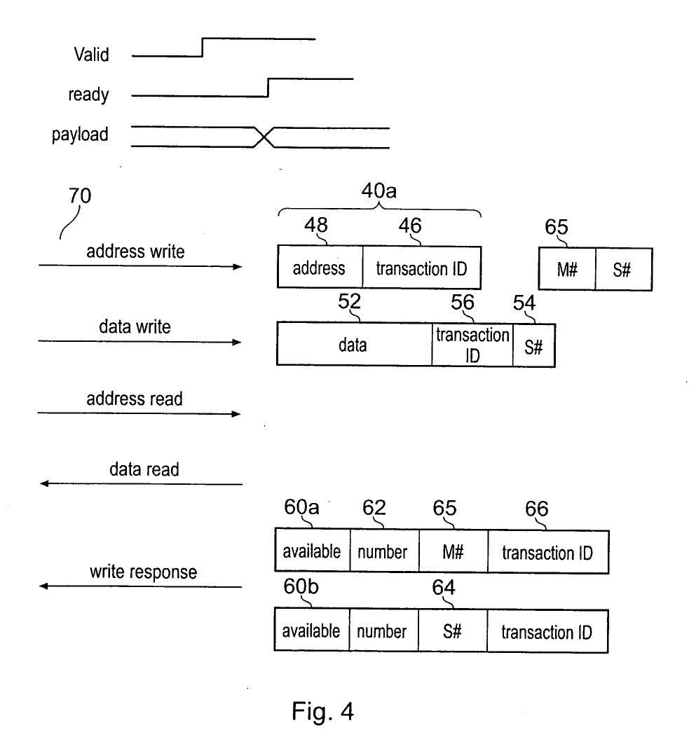

FIG. 4 shows the signals that are sent between master and slave in more detail. In the top of the Figure are shown the signals sent on each channel to initiate a transfer of information, shown as the payload. The initiator and the receiver agree that data has been transferred along the channel when the valid and the ready signal are both high on the rising clock edge. This “handshake” signifies to both the initiator and the receiver that the channel is free to perform a new data transfer in the next clock cycle. FIG. 4 also schematically shows a bus 70 with an address write, a data write, an address read, a data read and a write response channel. A data transaction request 40a is sent out on the address write channel. It comprises an address 48 and a transaction identifier 46 that identifies the transaction. It should be noted that in some embodiments, the transaction request does not comprise a transaction identifier. Transactions distinguished by different transaction IDs can be processed in any order. When this transaction request is received by interconnect logic 20 of FIG. 1 it determines which slave it is to be sent to from address 48 and then appends a master identifier to the transaction identifier and sends it to the appropriate slave. When the slave is ready to receive the data it sends an available request on the write response channel. Available request 60a is illustrated and comprises an indication that it is available which is basically a bit that distinguishes it from a write completed response which is also sent on this channel, it may also comprise a number 62 which indicates a number of data items of the data transaction request the slave is ready to receive and it comprises the master identifier 65 which was appended to the write transaction request that it received. It also comprises the transaction identifier 66. This is then sent to interconnect logic 20. Interconnect logic determines using comparison logic which master to send the available request to from the master identifier 65. Prior to sending it to that master it removes this identifier and appends an identifier of the slave it has just received this request from and thus slave identifier 64 is then appended to the amended available request 60b. This amended available request 60b is then sent to the appropriate master. The master can then send out a data signal 50 to the slave on the data write channel. This data signal 50 comprises data 52 the transaction identifier 56 and the slave identifier 54 which has been taken from the available request 60b that the slave received. The interconnect logic can then route the data to the appropriate slave and remove the slave identifier at the same time. If the write response included a number 62 as it does in this embodiment then the data that is sent is simply the number of data items specified by the that number.

In this way, the responses are successfully and simply routed using demulitplexer logic rather than requiring multiple comparisons of many stored identifiers.

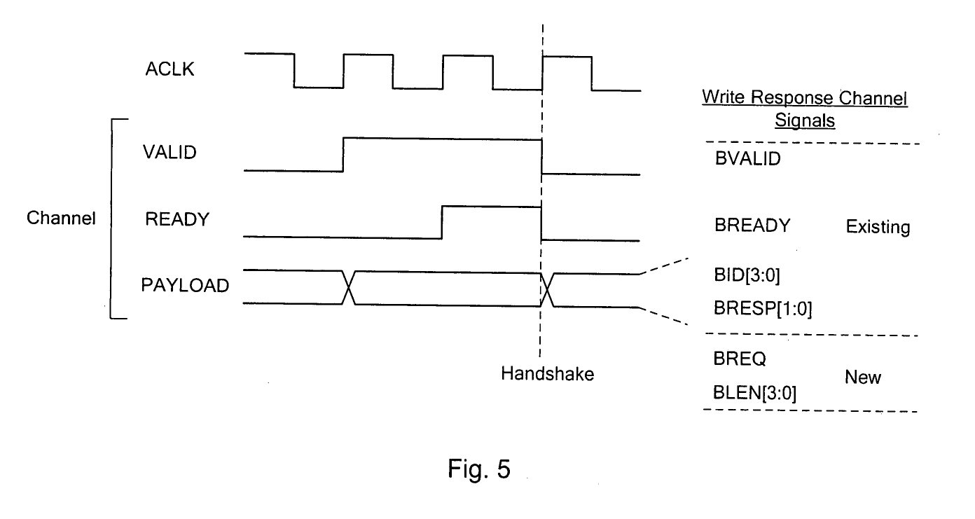

FIG. 5 shows the waveforms for a typical transfer on a generic AXI channel. The specific signal names for the AXI Write Response Channel (B Channel) are given on the right.

The extra signals for an implementation of the Write Data Request are also shown:
BREQ is a 1-bit signal used to indicate that the payload represents a write data request. A ‘0’ on this signal marks the payload as a conventional write data response. A ‘1’ marks the payload as a write data request.
BLEN is a 4-bit signal for an alternative implementation where the request can also specify the number of data transfers

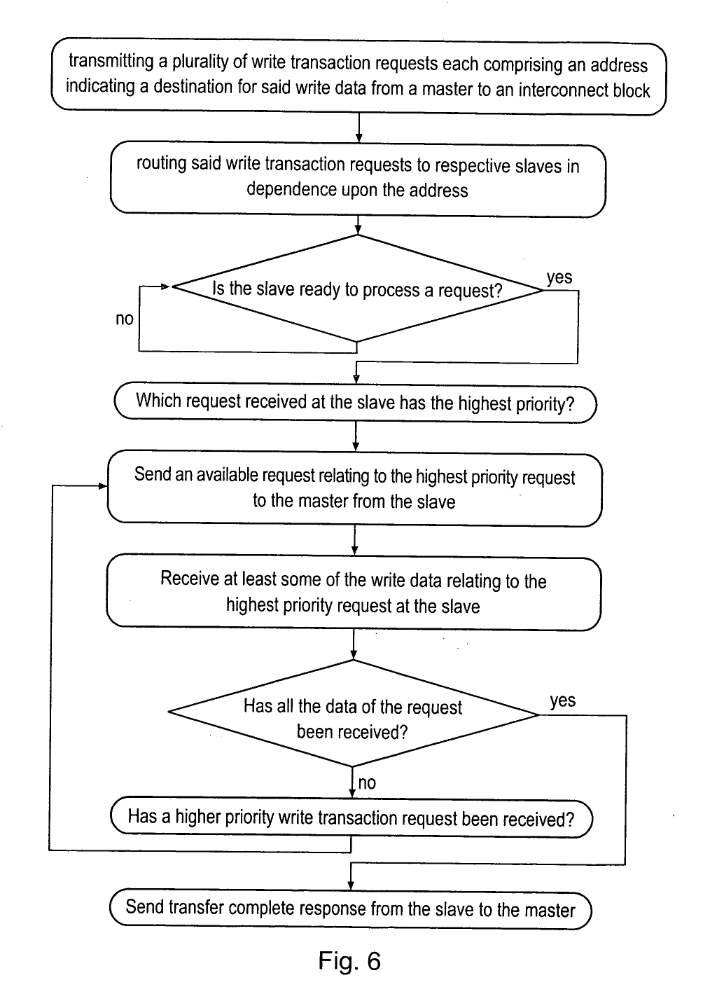

FIG. 6 shows a flow diagram showing a method according to an embodiment of the present invention. This flow diagram illustrates how a slave can process requests out of order and thereby allow some requests to have a higher priority and be processed more quickly.

Initially, a plurality of write transaction requests each comprising an address which indicates the destination of the write data are transmitted from a master to an interconnect block this interconnect block then routes these transaction requests to respective slaves in dependence upon the address specified in the write transaction request. At a particular slave the slave assesses whether it is ready to process a received request. If it is, then it determines which request it received has the highest priority. It then sends an available request relating to the highest priority request to the master. In response to this available request the master sends it at least some of the write data relating to this high priority request. This is then received at the slave.

The available request sent from the slave may indicate that it can only receive a number of data items at any one time and thus it may not be all of the data that is sent. When the data has been received at the slave, the slave assess whether all of the data items of the request have been received or not. It can tell this as the original write transaction request indicated the amount of data involved in that write transaction and it also knows how much data it has received. If all the data has been received then a transfer complete response is sent from that slave to the master and it is then ready to process a next request and it looks again to see which request has the highest priority. If not all the data has been received it then looks to see if a higher priority write transaction request has been received since it started processing the previous one. If a higher priority request has been received then it is this request that is then processed. If no higher priority write transaction request has been received then it continues to process the previous request and sends an available request back to the master for that request.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

Further particular and preferred aspects of the present invention are set out in the accompanying independent and dependent claims. Features of the dependent claims may be combined with features of the independent claims as appropriate, and in combinations other than those explicitly set out in the claims.

I claim:

1. A method of writing data from an initiator to a recipient via an interconnect block, comprising the steps of:
(i) transmitting a write transaction request comprising an address indicating a destination for said write data from said initiator to said interconnect block;
(ii) said interconnect block routing said write transaction request to said recipient in dependence upon said address;
(iii) in response to receipt of said write transaction request at said recipient, said recipient determining said recipient's availability for receiving write data relating to said write transaction request; and
(iv) in response to determining it is available transmitting an available request specific to said write transaction request to said interconnect block;
(v) said interconnect block routing said available request to said initiator;
(vi) said initiator transmitting at least some of said write data relating to said write transaction request to said interconnect block in response to receipt of said available request; and
(vii) said interconnect block routing said at least some of said write data to said recipient.

2. A method according to claim 1, wherein said write transaction request received at said recipient comprises a transaction identifier.

3. A method according to claim 2, wherein said write transaction request transmitted by said initiator comprises at least a portion of said transaction identifier.

4. A method according to claim 2, wherein said step (ii) of routing said write transaction request to said recipient by said interconnect block comprises appending at least a part of said transaction identifier to said transaction request received from said initiator prior to transmitting said transaction request to said recipient.

5. A method according to claim 2, wherein said step (ii) further comprises appending an initiator identification to said write transaction request prior to transmitting it to said recipient, said available request transmitted by said recipient comprising said transaction identifier and said initiator identification.

6. A method according to claim 5, wherein said step (ii) further comprises said interconnect block deriving a composite identifier from said transaction identifier within said write transaction request and said initiator identification and appending said composite identifier to said write transaction request.

7. A method according to claim 5, wherein said step (v) of said interconnect block routing said available request to said initiator comprises said interconnect block determining which initiator to route it to from said initiator identification and comprises said interconnect block removing said initiator identification from said available request and appending a recipient identification to said signal prior to transmitting it to said initiator.

8. A method according to claim 7, wherein said step (vi) of said initiator transmitting at least some of said write data comprises an initial step of said initiator appending said recipient identification and said transaction identification to said at least some of said write data prior to transmitting it.

9. A method according to claim 1, wherein said step (iii) of said recipient determining its availability comprises determining a number of data items it is available to receive, said available request transmitted comprising an indication of a number of data items said recipient is available to receive, and said step (vi) of said initiator transmitting at least some of said write data comprises said initiator transmitting said number of data items from said write data indicated in said recipient available request.

10. A method according to claim 9, wherein said step (iii) of said recipient determining its availability comprises continually determining said number of data items said recipient is available to receive and transmitting further available requests when it is determined that a further number of data items can be received said further available requests comprising said further number of data items, until said recipient has received all of said data items.

11. A method according to claim 1, comprising a further step (viii) of in response to said recipient determining said write transaction has completed, said recipient transmitting a write response.

12. A method according to claim 2, wherein said step (i) of transmitting a write transaction request is performed a plurality of times before steps (ii) to (vii) have completed, wherein step (iii) further comprises determining said recipient's availability for a particular write transaction from said plurality of write transaction requests received in dependence upon said transaction identifiers and at least one predetermined condition and step (iv) comprises transmitting said available request specific to a selected next write transaction request to be processed.

13. A method according to claim 12, wherein said predetermined condition comprises a priority rating of an initiator said write transaction request is received from.

14. Interconnect logic for coupling initiators and recipients within a data processing apparatus to enable transactions to be performed, each transaction comprising an address transfer from an initiator to a recipient and one or more data transfers between said initiator and said recipient, at least one of said transactions being a write transaction from said initiator to said recipient, said interconnect logic comprising:
(i) a plurality of connection paths operable to provide at least one address channel for carrying address transfers, at least one data channel for carrying data transfers, and at least one response channel for carrying a response from said recipient; wherein
(ii) said interconnect logic is responsive to receipt of a write transaction request comprising a write address from said initiator, to identify said recipient from said write address and to transmit said write transaction request via said address channel to said identified recipient; and
(iii) said interconnect logic is responsive to receipt of an available request corresponding to said write transaction from said recipient, to transmit said available request to said initiator; and
(iv) said interconnect logic is responsive to receipt of signals comprising at least some of said write data of said write transaction to transmit said at least some of said write data to said recipient.

15. Interconnect logic according to claim 14, wherein said write transaction received from said initiator comprises at least a portion of a write transaction identifier.

16. Interconnect logic according to claim 14, wherein said interconnect logic is operable to append at least a part of a write transaction identifier to said write transaction request prior to transmitting said write transaction request to said recipient.

17. Interconnect logic according to claim 14, wherein said available request is transmitted on said response channel.

18. Interconnect logic according to claim 14, wherein
(i) said interconnect logic is adapted to append an identifier of said initiator to said write transaction request prior to transmitting said write transaction request to said recipient;
(ii) said available request received from said recipient comprises said initiator identifier, said interconnect logic is able to identify said initiator to transmit said available request to, from said initiator identifier, said interconnect logic being adapted to append an identifier of said recipient to said available request received from said recipient and to remove said initiator identifier; and
(iii) write data received by said interconnect logic comprises said recipient identifier appended thereto, said interconnect logic identifying said recipient to transmit said write data to from said recipient identifier and being adapted to remove said recipient identifier prior to transmitting said write data.

19. An initiator for performing transactions with recipients via interconnect logic, said initiator comprising input and output logic for performing a write transaction, said output logic being adapted to output a write transaction request comprising a write address to a recipient via interconnect logic, and to not output write data associated with said write transaction until said input logic has received an available request relating to said transaction from said recipient, said output logic being adapted to output at least some of said write data to said recipient in response to receipt of said available request at said input logic.

20. An initiator according to claim 19, wherein said output logic is adapted to append a transaction identifier to said write transaction request prior to outputting it.

21. An initiator according to claim 18, wherein said available request received further comprises a composite identifier comprising a recipient identifier and a transaction identifier, said output logic being adapted to append said recipient identifier and said transaction identifier to said write data prior to outputting said write data.

22. An initiator according to claim 19, wherein said available request further comprises an indication of a number of data items, said output logic being adapted to output said number of data items from said write data in response to said available request and to await receipt of a further available request at said input logic before outputting further write data.

23. An initiator according to claim 19, wherein said available request is received from a response channel input at said initiator, and is discriminated from a write finish response by said input logic in dependence upon an identifying bit within said response channel

24. A recipient adapted to perform transactions with initiators via interconnect logic, said recipient comprising input and output logic, said input logic being responsive to receipt of a write transaction request comprising a transaction identifier and an address received from an initiator, to determine said recipient's availability to receive said write data and in response to determining said recipient is available, said output logic is adapted to output an available request comprising said transaction identifier.

25. A recipient according to claim 24, wherein said write transaction request further comprises an initiator identifier, said recipient being adapted to append said initiator identifier to said available request prior to outputting it.

26. A recipient according to claim 24, wherein said available request is output to a response channel and comprises an identification bit for identifying said request as said available request rather than a write finish indication.

27. A recipient according to claim 24, wherein said recipient is further adapted in response to said write transaction request to determine a number of items it can receive and to append said number to said available request, and to continue to perform said determination and output available requests until it detects it has received all of said write data.

28. A recipient according to claim 24, wherein said recipient further comprises selection logic, and in response to receipt of a plurality of write transaction requests said selection logic is adapted to select a next write transaction to process in dependence upon said write transaction identifiers and at least one predetermined condition, said recipient being adapted to output said available request specific to a selected next write transaction request to be processed.

29. A recipient according to claim 28, wherein said predetermined condition comprises a priority status of an initiator said write transaction is received from.

30. A data processing apparatus comprising at least one initiator according to claim 14, at least one recipient according to claim 24, said at least one initiator and said at least one recipient being interconnected via interconnect logic according to claim 19.

31. A data processing apparatus according to claim 30, wherein said at least one initiator comprises at least one master device, and said at least one recipient comprises at least one slave device.
